(19) United States
(12) Patent Application Publication
(10) Pub. No.: US 2012/0227296 A1
(43) Pub. Date: Sep. 13, 2012

(54) CURRENT-GENERATED PHOTO-LUMINESCENT HYBRID SIGN

(75) Inventors: O. Michael ROBERTS, Blacklick, OH (US); Thomas Wells Brignall, JR., Marcellus, MI (US)

(73) Assignee: GLOW LIGHT EMERGENCY EXIT PRODUCTS, LLC.

(21) Appl. No.: 13/473,700

(22) Filed: May 17, 2012

Related U.S. Application Data
(63) Continuation-in-part of application No. 13/276,452, filed on Oct. 19, 2011.
(60) Provisional application No. 61/344,881, filed on Nov. 2, 2010.

(51) Int. Cl. G09F 13/20

(52) U.S. Cl. 40/542

(57) ABSTRACT

A current-generated photo-luminescent hybrid sign is provided that includes one or more light emitting elements within a channel in the frame to evenly distribute light, while at the same time energizing a photo-luminescent glow material in case of power outage. A method of use of the sign is also provided.

### CROSS-REFERENCE TO RELATED APPLICATIONS

This is a continuation-in-part of prior U.S. application Ser. No. 13/276,452, filed Oct. 19, 2011, which claims the benefit of U.S. Provisional Application No. 61/344,881, filed Nov. 2, 2010, the disclosure of which is hereby incorporated by reference in its entirety.

### BACKGROUND OF THE INVENTION

The present invention relates to hybrid photo-luminescent signs, and more particularly to electrical signs with non-electric photo-luminescent backup.

Standard electric signs, such as exit signs, require 3 to 5 watts of energy and may operate on a battery backup when there is an electricity outage. However, such battery backups can be unreliable and battery replacement is often forgotten. Moreover, many of these signs use lamps that last for only a short period of time, such as 3 to 6 months.

Even newer signs with lamps that last longer, such as light emitting diodes (LEDs) that last up to 10 years, will not qualify for certain safety standards such as UL Laboratories Standard No. 924. Such signs do not emit enough light to be seen at 100 feet upon power outage.

The current-generated photo-luminescent hybrid sign of the present invention preferably does not include a battery backup but provides a luminescent sign even during a power outage, passes rigorous safety standards, and can be seen 100 feet away.

An embodiment of the inventive hybrid photo-luminescent sign uses electricity-powered LED lights that illuminate the sign internally, and in turn energize a photo-luminescent portion or portions that illuminate the sign in case of power outage. The photo-luminescent portions are preferably formed by a molded photo-luminescent sheet and a front plate with apertures to define the characters. The characters may also be screen printed. A power converter step-down unit is also included that is capable of automatically stepping down electricity voltage from either 277 volts or 120 volts to 12 volts. The sign also includes a frame with a channel therein for housing an elongated board of LED lights. The channel is preferably narrowed as it extends inwardly to better focus the light emitted from the LEDs for a more even light output.

Another embodiment is a hybrid photo-luminescent sign, the sign comprising one or more photo-luminescent plates, and an externally disposed illumination source, such as a strip of LEDs. The illumination source may be disposed adjacent the top of the plate(s), the bottom of the plate(s), or both.

Still another embodiment of the inventive hybrid photo-luminescent sign includes a sign plate which depends from an inner housing. Attached to the inner housing is a light source, preferably a light bar with multiple LEDs. Attached to the inner housing is an outer housing which is capable of connection to a ceiling or wall of a building. The sign plate includes photo-luminescent characters that are charged by the light source.

Other advantages, objects and/or purposes of the invention will be apparent to persons familiar with constructions of this general type upon reading the following specification and inspecting the accompanying drawings.

### BRIEF DESCRIPTION OF THE DRAWING FIGURES

FIG. 1 is a front perspective view of a hybrid photo-luminescent sign of the present invention;

FIG. 2 is an elevational exploded view of the frame and light strip of the sign of FIG. 1;

FIG. 3A is an elevational view of an outer part of a front face panel of the sign of FIG. 1;

FIG. 3B is an elevational view of a first embodiment of an inner part of a front face panel of the sign of FIG. 1;

FIG. 3C is an elevational view of a second embodiment of an inner part of a front face panel of the sign of FIG. 1;

FIG. 4 is a cross-sectional view of the frame taken along line IV-IV in FIG. 2;

FIG. 5 is a cross sectional view of the sign taken along line V-V in FIG. 1;

FIG. 6 is an exploded perspective view of a hybrid-photo-luminescent sign of the present invention with a side mount;

FIG. 7 is a perspective view of wiring detail of an external power converter to be used with the sign of FIG. 6;

FIG. 8 is a perspective view of a second embodiment of a hybrid photo-luminescent sign of the present invention;

FIG. 9 is an elevational front cross-sectional view of the embodiment of FIG. 8, taken along line IX-IX in FIG. 8;

FIGS. 10a-10c are side elevational views of embodiments of the hybrid photo-luminescent sign of FIG. 8; and

FIG. 11 is a perspective view of a third embodiment of a hybrid photo-luminescent sign of the present invention.

### DETAILED DESCRIPTION OF THE PREFERRED EMBODIMENT

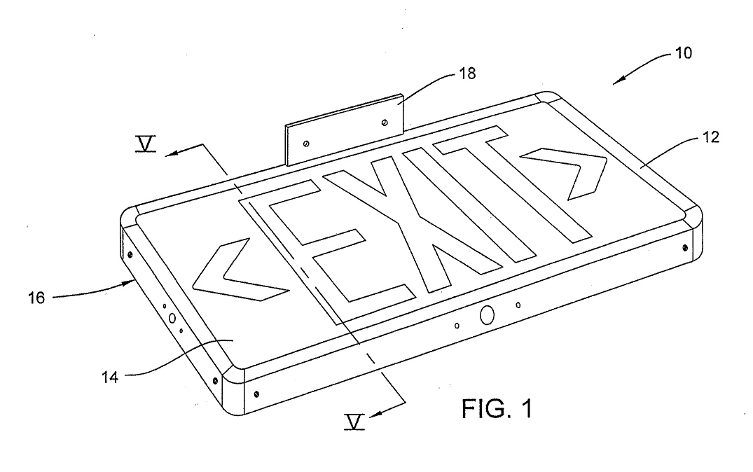

Certain terminology will be used in the following description for convenience and reference only and will not be limiting. The words “up,” “down,” “left,” and “right” will designate directions in the drawings to which reference is made. The words “front” and “rear” will designate the front of the sign facing the reader in FIG. 1 and the other directions will follow accordingly. Such terminology will include derivatives and words of similar import.

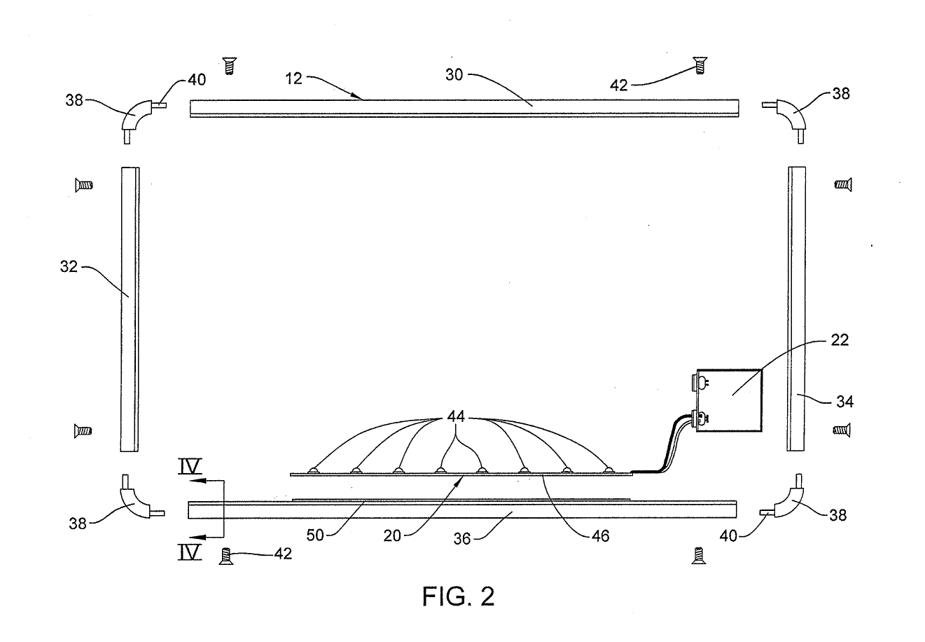

FIG. 1 shows a hybrid current-generated photo-luminescent sign 10 that generally includes a frame 12, a front face plate 14, a rear plate 16, and a mounting bracket 18. The sign 10 also generally includes a light source 20 and a power converter 22 (see FIG. 2).

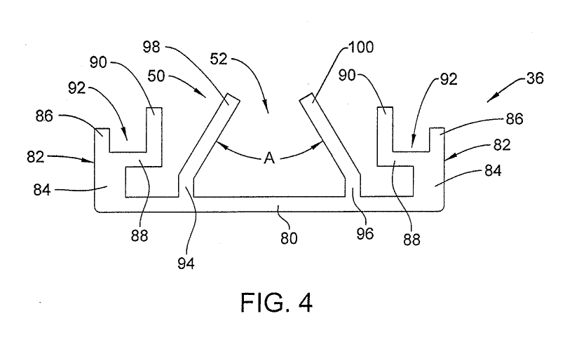

FIG. 2 shows the frame 12 in an exploded view, along with the light source 20 and the power converter 22, which reside interiorly of frame 12. The frame 12 includes a top rail 30, a left rail 32, a right rail 34, and a bottom rail 36. The rails are attached to one another by curved corner pieces 38, which each include legs 40 for secure attachment to the lengthwise rails by fasteners such as screws 42. The frame 12 is preferably made of extruded aluminum with cast aluminum corners 38. The bottom rail 36 includes a central channel structure 50 defining a channel 52, which is shown in detail in FIG. 4 and described in more detail below.

Light source 20 preferably includes a plurality of light emitting elements 44 which are aligned equidistantly along an elongated circuit board 46. Light emitting elements 44 are preferably light emitting diodes (LEDs) and most preferred are 240 degree lamps. For a standard exit sign, eight aligned LEDs are preferred, but more or less may be used, depending on the desired light output, and size and shape of the sign. The board 46 preferably draws 0.24 amps at 2.88 watts of power. The board is driven at 80% power capacity, which results in a reduced heat build-up and increases the life expectancy of the entire light source 20. The sign 10, in turn, operates on between 0.5 and 1.0 watts of power.

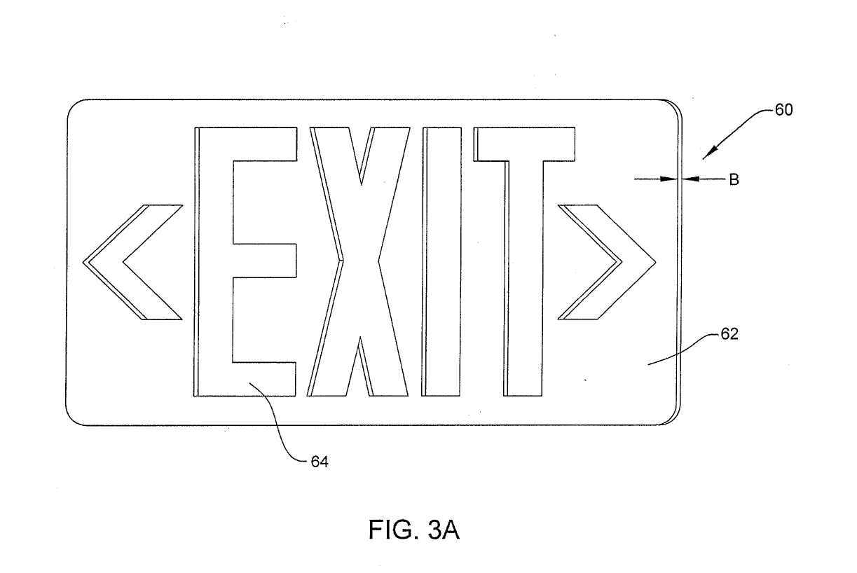

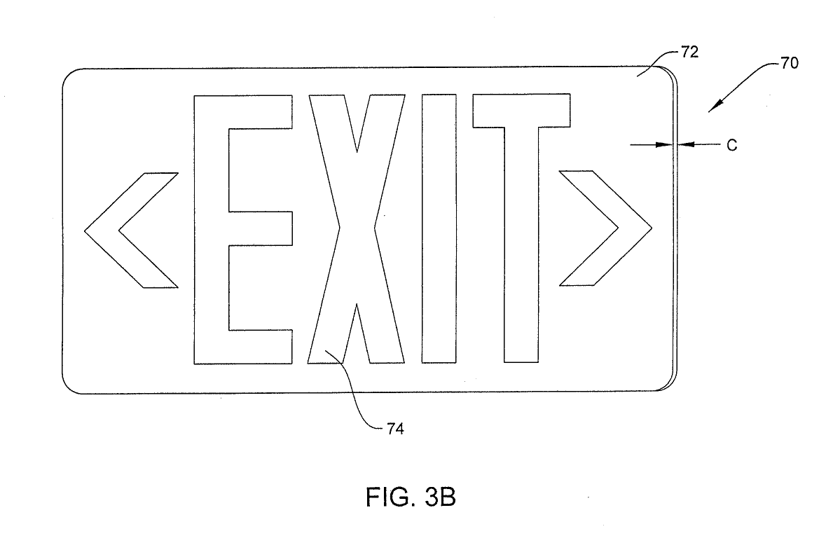

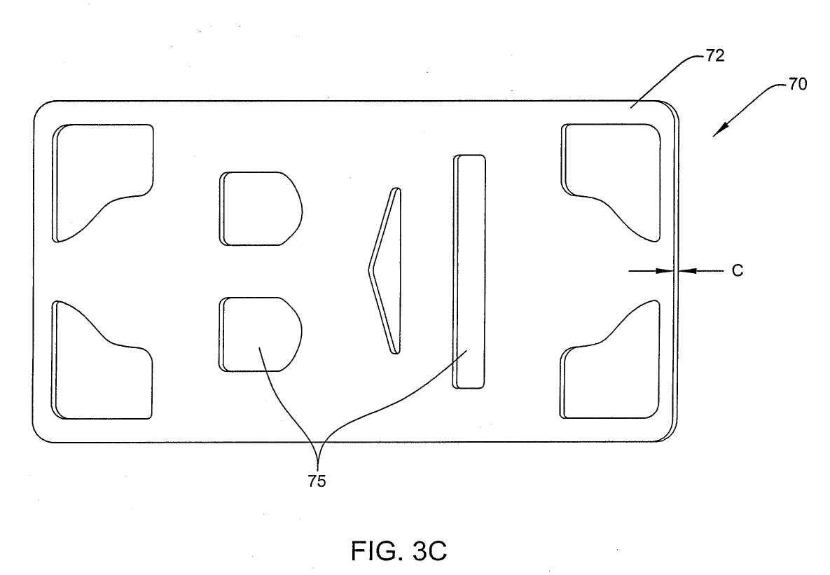

FIG. 3A shows a first component of front face plate 14. FIGS. 3B and 3C show two alternatives of a second component of front face plate 14. Shown in FIG. 3A is an outer cover plate 60. Outer cover plate 60 is preferably made of a sturdy metal material such as aluminum, and has a thickness designated as “B” in FIG. 3A. The outer cover plate 60 includes a face 62 and character apertures 64 which are formed by water jet cutting, stamping, routing, or another method, followed by deburring of the edges. Thickness “B” may be any suitable thickness, but is preferred to be 0.04 inches if outer cover plate 60 is of aluminum.

FIG. 3B depicts a second component of a front face plate 14, which is an inner cover plate 70. Inner cover plate 70 has a face 72 and a thickness designated by the letter “C” in FIG. 3B. The thickness “C” is large enough that the inner cover plate 70 is substantially rigid but thin enough to fit within the confines of the frame 12 and to allow light therethrough. On face 72 are characters 74, which are of a photo-luminescent material, preferably strontium aluminum oxide. A suitable strontium aluminum oxide is model GLL300E manufactured and sold by Nemoto Shenzhen Limited of Tokyo, Japan. The GLL300E substance comprises strontium aluminum oxide having a particle size of about 90 microns. A higher particle size is preferable to achieve a quicker charge and a much longer discharge of light in an emergency. The characters 74 are placed on face 72 by any useful means, but preferably by screen printing using known screen printing techniques, and are most preferably screen printed in eight layers. The inner cover plate 70 is preferably of a semi-transparent plastic material that is substantially rigid, and more preferably is 0.060 inch thick polycarbonate resin thermoplastic, such as Lexan®.

In an alternative, and preferred, embodiment of inner cover plate 70 as shown in FIG. 3C, the entire plate is made of a photo-luminescent material. The plate is made of a resilient substance that is energized by exposure to light, preferably a mixture of polypropylene and strontium aluminum oxide, and more preferably a mixture of 60% by weight polypropylene and 40% strontium aluminum oxide which has a particle size of 30-40 microns. A suitable strontium aluminum oxide for this embodiment is model G300M, manufactured and sold by Nemoto Shenzhen Limited of Tokyo, Japan. The polypropylene/strontium aluminum oxide mixture is preferably pelletized and extrusion molded into inner cover plate 70. Using such a mixture, the inner cover plate may be between 0.020 inches to 0.100 inches in thickness, but is preferably between 0.065 inches and 0.070 inches in thickness. The inner cover plate 70 of FIG. 3C may be one solid sheet but because outer cover plate 60 will be used, the inner cover plate 70 may include apertures 75, where the characters of the outer cover plate 60 are not positioned, to decrease the amount of material used.

FIG. 4 depicts a cross-section of the bottom rail 36 of the frame 12. The bottom rail 36 includes a base 80, two outer holding structures 82, which are mirror-images of each other, and channel structure 50, which is centrally located between outer holding structures 82. Outer holding structures 82 each include an upwardly extending member 84 which is attached to the base 80, a first upward projection 86 which extends upwardly from member 84 and defines the outer periphery of the bottom rail 36. A cantilevered arm 88 extends inwardly from member 84, and a second upward projection 90, which is interior with respect to projection 86, extends upwardly from the cantilevered arm 88. Projection 86, arm 88, and projection 90 together define a groove 92, in which the edges of one or more panels may reside.

Channel structure 50 includes, and thus channel 52 is defined, in part, by a portion of base 80. Extending upwardly from base 80 is a first leg 94 and a second leg 96, which are spaced from each other to create an outer channel width adjacent the base 80. Legs 94 and 96 are generally perpendicular to base 80. Extending inwardly and toward each other from legs 94, 96 are inner members 98, 100. Inner members 98, 100 are preferably straight, but do not need to be. If straight, the inner members 98, 100 are disposed at an angle “A” with respect to one another. The angle “A” is preferably between 50° and 70°, and more preferably 60°. Inner members 98, 100 terminate spaced from one another with an inner width between their ends that is less than the outer channel width between the legs 94, 96. The inner width is preferably between 35% and 40% of the outer width between the legs 94, 96, and is preferably less than 0.25 inches. Base 80; legs 94, 96; and inner members 98, 100 together define channel 52. Channel 52 is sized and shaped to receive board 46 and light emitting elements 44. Channel 52 preferably extends the majority of the length of the bottom rail 36.

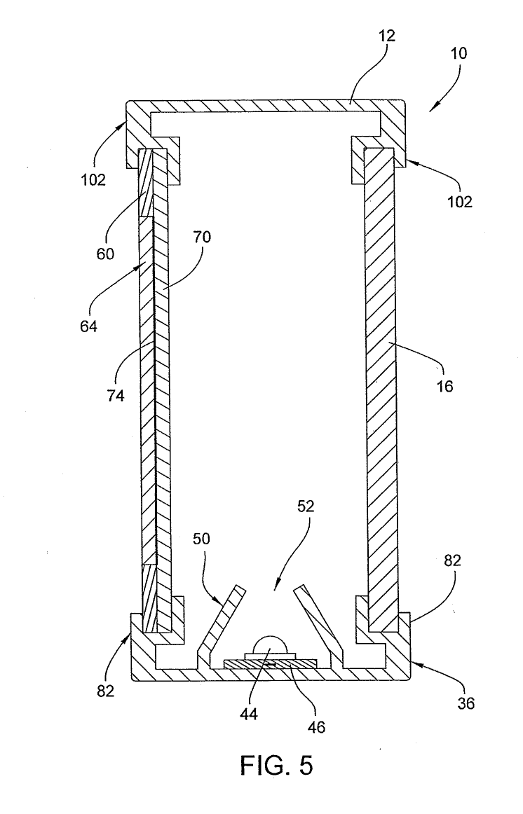

FIG. 5 is a cross-section of the current-generated photo-luminescent hybrid sign 10. The top portion of frame 12 includes outer holding structures 102 similar to outer holding structures 82. The outer holding structures 82, 102 retain edges of the outer cover plate 60 and inner cover plate 70 snugly at the front of the sign 10, and the rear plate 16 at the rear of the sign 10. In front face plate 14, photo-luminescent portions of the face 72 align with apertures 64 such that the characters 74 can be seen through the apertures 64. Channel 52 houses board 46 and LEDs 44 such that the light emitted from the LEDs 44 is focused upwardly and lights sign 10 while at the same time energizing characters 74 in case of power outage.

In operation, sign 10 is mounted to a ceiling or wall using mounting bracket 18. The sign 10 is hard wired to the electrical system of the building by extending wires through an aperture (not shown) in the frame 12 to the electrical system of the building. Upon hard wiring to the building electricity source, (which may be 120 volt or 277 volt), the step-down converter 22 converts the voltage to 12 volts and the 12-volt electrical current is transmitted to the board 46, which in turn energizes light emitting elements 44. The light emitting elements 44 light the sign entirely while electricity is being provided to the sign 10. At the same time, light from the light emitting elements 44 is energizing the photo-luminescent portion of the sign in case of power outage. During a power outage, the photo-luminescent portions glow such that the characters 74 of sign 10 can be seen at least 100 feet away from the sign for 90 minutes after the power outage. Thus, the sign 10 meets or exceeds all government energy and environmental building regulations and requirements.

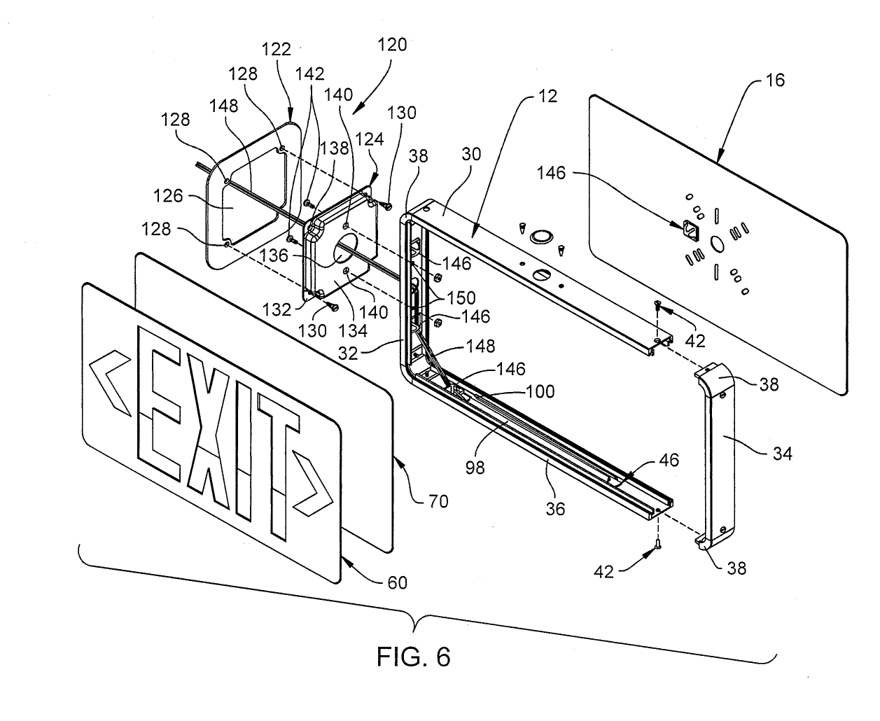

FIG. 6 shows an alternative mounting and power supply structure. The sign of FIG. 6 has the same components as that shown in FIGS. 1-5 except that it does not include a mounting bracket 18 attached to top rail 30, nor is the power converter 22 positioned inside the frame 12 of the hybrid current-generated photo-luminescent sign 10. This embodiment includes a wall mount 120 which generally includes a beauty ring 122 and a raised cover 124. The beauty ring 122 is generally square in shape and includes a central generally square-shaped aperture 126, sized large enough for multiple wires to be received therethrough. The beauty ring 122 also includes a plurality of screw holes 128, which are preferably positioned adjacent the respective corners of the central aperture 126, and configured for receiving screws 130 used for attaching the raised cover 124. Raised cover 124 is also generally square in shape and includes a base portion 132 and a raised portion 134. The raised portion 134 includes a central aperture 136, which is preferably circular in shape and is sized to receive a plurality of wires therethrough. The base portion 132 includes exterior screw holes 138 for receiving and retaining screws 130. The raised portion 134 includes two inner screw holes 140, which are sized and shaped to receive screws 142 for attachment of the raised cover 124 to the frame 12 of the sign 10. The screw holes 140 are aligned vertically adjacent the central aperture 136. On the interior of frame 12 and on the inner wall of back plate 16 are wire retainers 146, which each assist in retaining and stabilizing wires 148 which are used to power the circuit board 46 for energizing light emitting diodes 44. One side rail of frame 12, such as left rail 32, includes not only one or more wire retainers 146, but also screw holes 150 which are used to receive screws 142 for attachment of sign 10 to the wall mount 120.

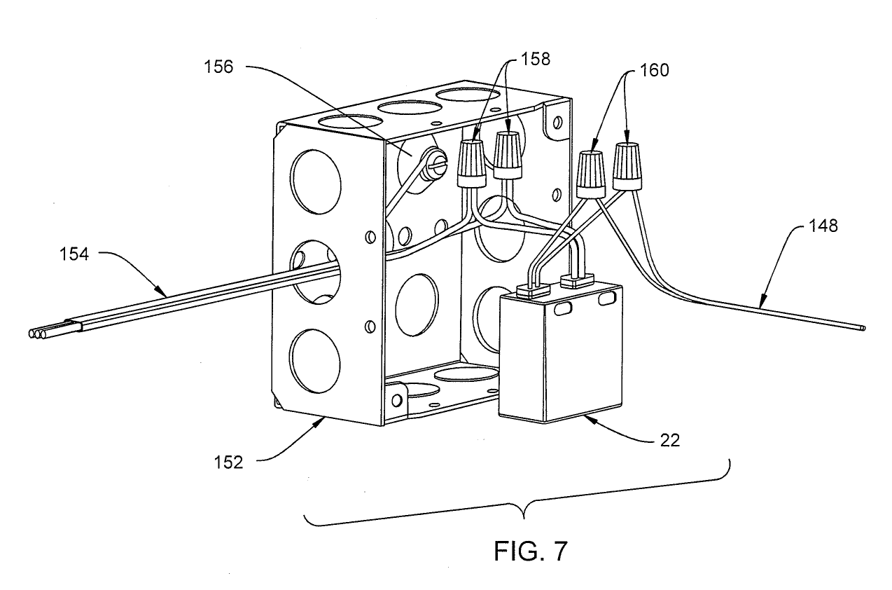

FIG. 7 shows the external wiring detail for the FIG. 6 embodiment of sign 10. The structure includes an electrical box 152 which may be any kind of electrical box including a standard four-inch square aluminum box. Incoming power wires 154 are threaded into the box 152 and one of the wires 154 is connected to a ground 156. Two incoming alternating current power wires 158 carry between 100 volts and 277 volts of electricity to the power converter 22. Attached to the power converter is an outgoing direct current power connection 160 which results in a 12-volt electrical direct current being fed through wires 148 into the exit sign 10.

To mount the sign 10 using the wall mount 120 shown in FIG. 6, a rubber band (not shown) is placed around the top and bottom of the right rail 34 of frame 12. Screws 42 that attach right rail 34 to the remainder of the frame are removed, followed by the removal of the right rail 34 and the attached corner pieces 38. The outer cover plate 60 and inner cover plate 70 are then removed from the frame 12. If not already done, left rail 32, for example, is attached to the wall mount 120 as described above. The LED wires 148 are routed through a hole in left rail 32, through the central aperture 136 of the raised cover 124, through the central aperture 126 of the beauty ring 122 and to the electrical box 152 for connection to the power converter 22. After the wires 148 are correctly assembled, the outer cover plate 60 and inner cover plate 70 are slid back into the frame 12. The right rail 34 is then reattached to the remainder of the frame 12 and screws 42 are reinserted to secure the right rail 34 to the remainder of the frame 12 via corner pieces 38. After the sign is mounted using wall mount 120, the AC power supply is energized and the exit sign 10 will illuminate.

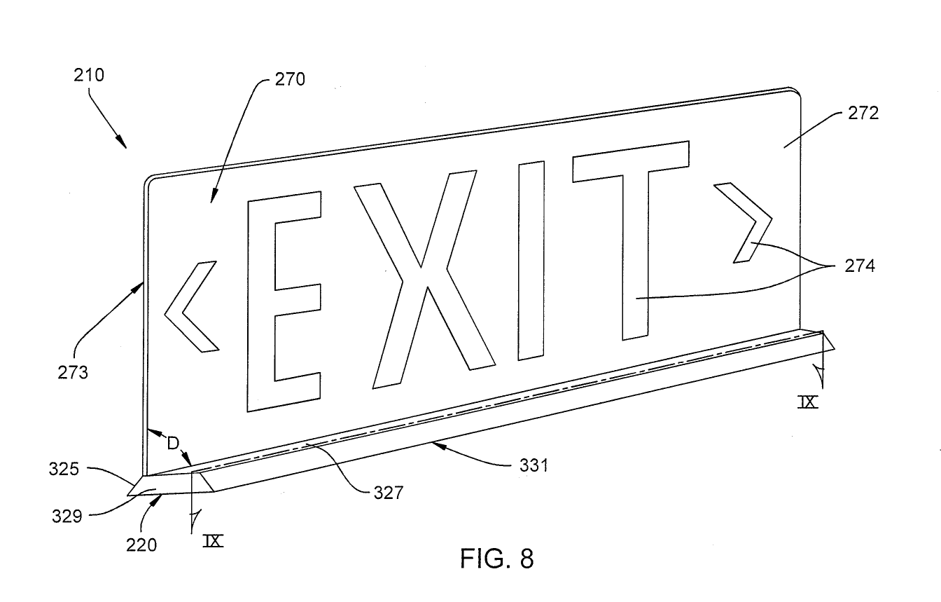

FIGS. 8-10 show an alternative embodiment of a current-generated photo-luminescent hybrid sign. The sign 210 of this embodiment includes a generally rectangular sign plate 270 that includes a front face 272 and a rear face 273. Photo-luminescent characters 274 are attached to the front face, preferably by screen printing, as described above. The characters 274 are preferably of strontium aluminum oxide, such as part number GLL300E manufactured and sold by Nemoto Shenzhen of Tokyo, Japan. Other materials which are photo-luminescent are also contemplated.

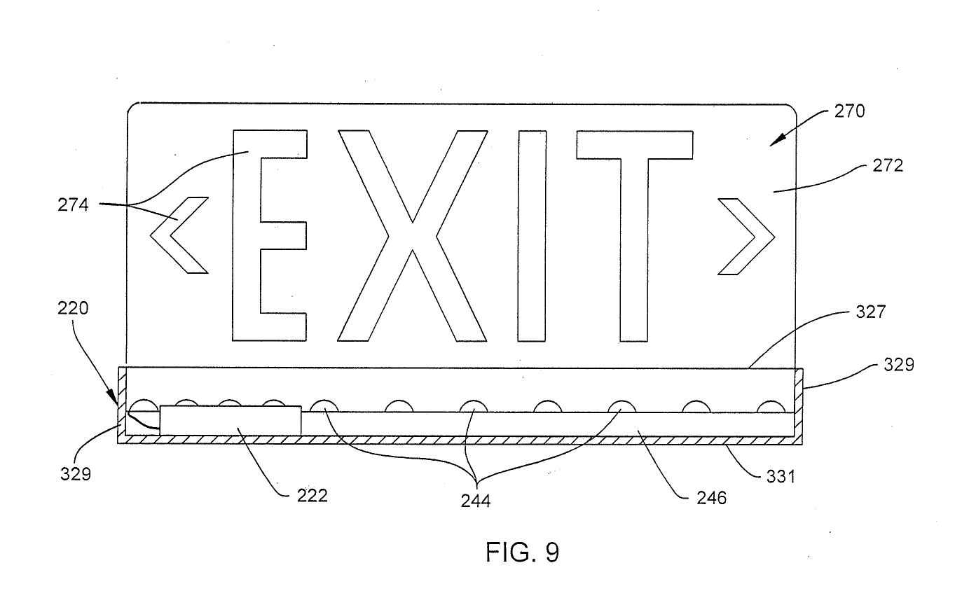

Sign 210 also includes a light source 220 as shown in FIGS. 8-10. Light source 220 includes a housing 325 which has a top wall 327, a bottom wall 331, and opposing side walls 329. Top wall 327 is of a material that allows light therethrough, but preferably is such a structure or texture so that light is diffused to provide a substantially even wash of light to the characters 274. At least one of the walls, and preferably all of them other than top wall 327, are non-light transmitting. As shown in FIG. 9, inside the housing 325 is a power converter 222 that is capable of converting an electrical current of either 120 volt or 277 volt to 12-volt direct current electricity which is transmitted to a circuit board 246, attached to which are multiple lights 244. At least a majority of the lights 244 are positioned in front of the sign plate 270. The lights 244 are preferably light emitting diodes, but may be any practical light emitting members. Alternatively, power converter 222 may be positioned outside housing 325, adjacent an electric box as shown in FIG. 7 or other arrangements.

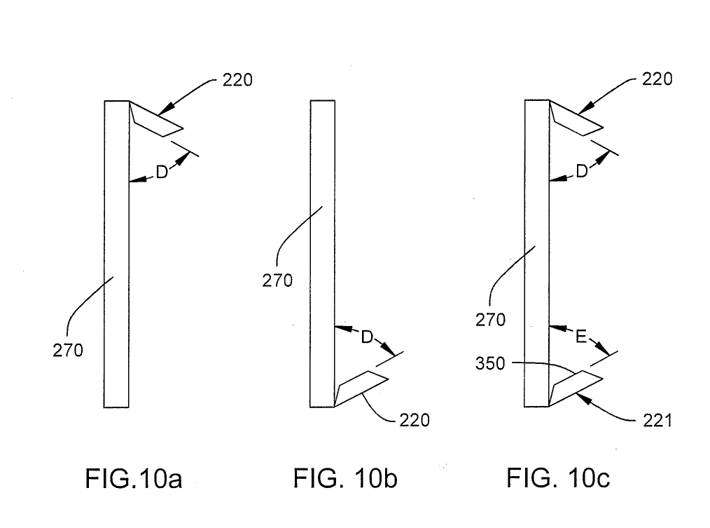

As shown in FIG. 8 and FIG. 10a-10c, the top 327 of the housing 325 is in a plane which is, with respect to the plane in which the plate 270 resides, 90° or less. This angle is depicted by the letter “D” in FIGS. 8 and 10a-10c. Also, as shown in FIGS. 10a-10c, the light source 220 may be positioned adjacent the top of the sign plate 270 (FIG. 10a), adjacent the bottom of the sign plate 270 (FIG. 10b), or positioned adjacent the top of sign plate 270 in addition to a second light source 221 positioned adjacent the bottom of the sign plate 270 (FIG. 10c). Second light source 221 has a top 350 which is in a plane that is at an angle of 90° or less with respect to the plane in which the sign plate 270 resides. This angle is denoted by the letter “E” in FIG. 10c.

In operation, sign plate 270 is mounted to a wall, a ceiling, or other structure such that the characters 274 are easily visible adjacent the egress of a building or area of a building. Light source 220 (with or without additional light source 221) is mounted either to the sign plate 270 or adjacent structure in a way depicted in one of FIGS. 10a, 10b, and 10c. The light source 220 is hardwired to the building electricity source (which may be 120 volt or 277 volt), and the converter 222 converts the electrical current to 12 volts which is transmitted to the board 246, which in turn energizes the light emitting elements 244. The light emitting elements 244 illuminate the entire face 272 of sign plate 270 while electricity is being provided to the sign 210. At the same time, light from the light emitting elements 244 is energizing the photo-luminescent portions of the sign (i.e. characters 274) in case of power outage. During a power outage, the photo-luminescent portions glow such that the characters 274 of sign 210 can be seen at least 100 feet away from the sign for 90 minutes after the power outage. Thus, the sign 210 meets or exceeds government energy and environmental building regulations and requirements.

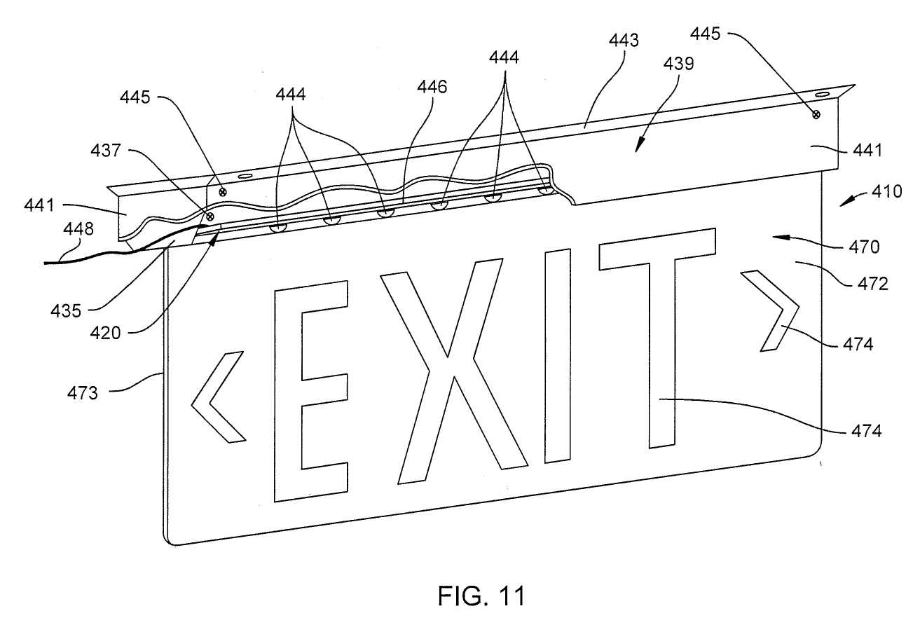

FIG. 11 depicts another embodiment of a hybrid photo-luminescent sign 410. The sign 410 includes a sign plate 470 which has a front face 472. On the front face 472 are photo-luminescent characters 474, which are preferably attached by screen printing as described above. The characters 474 are preferably of strontium aluminum oxide, such as part number GLL300E manufactured and sold by Nemoto Shenzhen of Tokyo, Japan. Other materials which are photo-luminescent are also contemplated. The sign plate 470 also includes a rear face 473. The sign plate 470 depends from, and is fixedly attached to, an inner housing 435. The inner housing 435 includes structure internally to receive the top portion of the sign plate 470. The internal structure may affix the inner housing 435 to the sign plate 470 or a fastener 437, such as a bolt or screw may be used to affix the sign plate 470 to the inner housing 435.

The inner housing 435 is attached to and resides within an outer housing 439. The outer housing 439 preferably includes four generally vertical walls 441 which depend from a base 443. The walls 441 are preferably opaque. The base 443 attaches to a ceiling or other structural item to hold the sign 410 in place. The outer housing 439 is attached to the inner housing 435 by fasteners 445, such as screws or bolts.

Extending outwardly from the inner housing 435 is a light source 420. The light source 420 includes one or more light emitting elements 444 which are preferably light emitting diodes (LEDs). The light emitting elements 444 are aligned equidistantly along an elongated circuit board 446. The circuit board 446 is attached to one or both of the inner housing 435 and the outer housing 439 and preferably fits entirely within the outer housing 439. The light source 420 is attached to an external electricity source, such as the wiring and converter detail shown in FIG. 7, via one or more wires 448.

In operation, the external electricity source provides electrical power through wire 448 to the light source 420, which is energized, thereby illuminating the light emitting elements 444. The light emitting elements 444 emit light generally downwardly to illuminate the sign plate 470 during normal operation. At the same time, the light from the light emitting elements 444 is energizing the photo-luminescent characters 474 in case of power outage. During a power outage, the characters 474 are illuminated due to their material properties, such that the characters 474 of sign 410 can be seen at least 100 feet away from the sign for 90 minutes after the power outage. Thus, the sign 410 meets or exceeds government energy and environmental building regulations and requirements.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A photo-luminescent sign comprising:
a sign plate comprising a front and a back, the front of the sign plate having photo-luminescent characters thereon, the sign plate in a sign plate plane;
a light housing comprising at least one wall with a light-diffusing characteristic;
a plurality of lights within the light housing, the lights positioned within the housing and configured to emanate light through the wall with a light-diffusing characteristic; and
a power converter in electrical connection with the lights, and adapted to receive electricity at a first voltage and deliver electricity to the lights at a second voltage,
at least a majority of the light housing positioned in front of the sign plate plane and configured such that the light illuminates the sign and directs light to the photo-luminescent characters when electricity is supplied to the lights.

2. The photo-luminescent sign of claim 1, wherein the housing has a first wall in a first wall plane, the first wall allowing light therethrough and there being an angle of less than 90° between the sign plate plane and the first wall plane.

3. The photo-luminescent sign of claim 1, wherein the sign plate has a top, and the light housing is disposed adjacent the top of the sign plate.

4. The photo-luminescent sign of claim 1, wherein the plurality of lights are light-emitting diodes.

5. The photo-luminescent sign of claim 1, wherein the power converter is positioned within the light housing.

6. The photo-luminescent sign of claim 2, wherein the housing has a second wall opposing the first wall, the second wall being opaque.

7. The photo-luminescent sign of claim 1, wherein the photo-luminescent characters can be seen at 100 feet away from the sign for at least 90 minutes after the photo-luminescent characters are fully charged.

8. A photo-luminescent sign comprising:
a generally rectangular sign plate having a top, a bottom, a front surface, and a back surface, the front surface having one or more photo-luminescent characters thereon, the photo-luminescent characters of a substance that is energized by light and when fully energized can be seen from at least 100 feet for at least 90 minutes;
at least one light-emitting member adjacent the top of the sign plate, the at least one light-emitting member within a housing, the housing having at least one non-light-transmitting wall, the at least one light-emitting member positioned relative to the sign plate to emit light onto the photo-luminescent characters when the at least one light-emitting member is illuminated; and
a power converter in electrical communication with the at least one light-emitting member and capable of converting an electrical current having between a 100V voltage and a 277V voltage to a 12V voltage.

9. The photo-luminescent sign of claim 8, the housing further comprising a light-transmitting wall which includes a diffuser.

10. The photo-luminescent sign of claim 8, wherein the housing is an outer housing and the sign further comprises an inner housing to which the sign plate is attached.
